(19) United States
(12) Patent Application Publication
(10) Pub. No.: US 2025/0307671 A1
(43) Pub. Date: Oct. 2, 2025

(54) DATA CORRECTION METHOD AND COMPUTING APPARATUS USED FOR MACHINE LEARNING, AND COMPUTER-READABLE MEDIUM

(71) Applicant: Wistron Corporation, New Taipei City (TW)

(72) Inventor: Chih-Ming Chen, New Taipei City (TW)

(73) Assignee: Wistron Corporation, New Taipei City (TW)

(21) Appl. No.: 18/733,790

(22) Filed: Jun. 4, 2024

(30) Foreign Application Priority Data
Mar. 29, 2024 (TW) 113112188

(51) Int. Cl. G06N 5/04; G06N 3/082

(52) U.S. Cl. CPC G06N 5/04; G06N 3/082

(57) ABSTRACT

A data correction method, a computing apparatus used for machine learning, and a computer-readable medium are provided. In the method, multiple pieces of sensing data are related, and a causal relationship is generated. The causal relationship is compared, and a comparison result is generated. The comparison result is used for modifying the sensing data. The machine learning model is trained through inputting the modified sensing data. Therefore, the correctness of data can be ensured.

### CROSS-REFERENCE TO RELATED APPLICATION

This application claims the priority benefit of Taiwan application serial no. 113112188, filed on Mar. 29, 2024. The entirety of the above-mentioned patent application is hereby incorporated by reference herein and made a part of this specification.

### BACKGROUND

### Technical Field

The disclosure relates to a machine learning technology, and in particular to a data correction method and a computing apparatus for machine learning, and a computer-readable medium.

### Description of Related Art

Autonomous driving systems can bring convenience to drivers. However, the system may be at risk of malicious attacks or data tampering.

A recent security report pointed out that placing three stickers on the road to pretend to be lane guides can trick a vehicle using an autonomous driving system into changing lanes, and even causing the vehicle to follow the route guided by the stickers and enter the opposite lane. Since the self-driving system detects these stickers through computer vision, the system interprets the stickers as the turning of lanes. Whether the driver notices the abnormal steering or not, it can cause danger. Hackers can even change the system's recognition of speed limit signs, causing vehicles to speed. In addition, if the hacker's goal is to deceive the computer vision system of the automated guided vehicle (AGV), it may cause the driving route to change or lead to an accident.

### SUMMARY

The disclosure provides a data correction method and a computing apparatus for machine learning, and a computer-readable medium, which may correct tampered or erroneous data.

The data correction method for machine learning in the embodiment of the disclosure includes (but is not limited to) the following steps: relating multiple pieces of sensing data and generating a causal relationship; comparing a causal relationship and generating a comparison result; and training the machine learning model by inputting the modified sensing data. The comparison result is configured to modify the sensing data.

The computing apparatus for machine learning in the embodiment of the disclosure includes (but is not limited to) a storage and a processor. The storage stores a program code. The processor is coupled to the storage. The processor loads the program code and executes: relating multiple pieces of sensing data and generating a causal relationship; comparing a causal relationship and generating a comparison result; and training the machine learning model by inputting the modified sensing data. The comparison result is configured to modify the sensing data.

The non-transitory computer-readable medium of the embodiment of the disclosure loads the program code through the processor and performs the following steps: relating the multiple pieces of sensing data and generating the causal relationship; comparing the causal relationship and generating the comparison result; and training the machine learning model by inputting the modified sensing data. The comparison result is configured to modify the sensing data

To make the aforementioned more comprehensible, several embodiments accompanied with drawings are described in detail as follows.

### BRIEF DESCRIPTION OF THE DRAWINGS

FIG. 1 is a block diagram of a computing apparatus according to an embodiment of the disclosure.

FIG. 2 is a flow chart of a data correction method for machine learning according to an embodiment of the disclosure.

FIG. 3 is a schematic diagram illustrating an application scenario of road driving according to an embodiment of the disclosure.

FIG. 4 is a schematic diagram illustrating the reference causal graph corresponding to FIG. 3 according to an embodiment of the disclosure.

FIG. 5 is a schematic diagram illustrating an application scenario of information deception according to an embodiment of the disclosure.

FIG. 6 is a schematic diagram illustrating the causal graph to be tested corresponding to FIG. 5 according to an embodiment of the disclosure.

FIG. 7 is a schematic diagram illustrating a corrected causal graph to be tested according to an embodiment of the disclosure.

### DESCRIPTION OF THE EMBODIMENTS

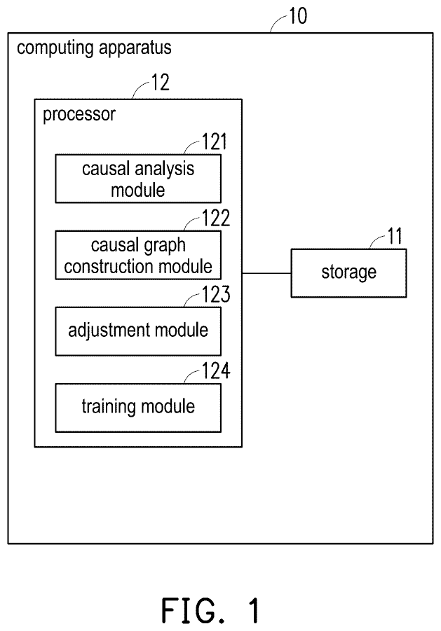

FIG. 1 is a block diagram of a computing apparatus 10 according to an embodiment of the disclosure. Referring to FIG. 1, the computing apparatus 10 includes (but is not limited to) a storage 11 and a processor 12. The computing apparatus 10 may be a computer host, a server, a smartphone, a tablet, a wearable apparatus, a smart home appliance, a vehicle-mounted apparatus, or other electronic apparatus.

The storage 11 may be any type of fixed or removable random access memory (RAM), read only memory (ROM), flash memory, hard disk drive (HDD), solid-state drive (SSD) or similar elements. In an embodiment, the storage 11 is used to store program codes, software modules (for example, a causal analysis module 121, a causal graph construction module 122, an adjustment module 123, and/or a training module 124), configurations, data (for example, machine learning parameters, causal variables, causal relationships, or causal diagrams) or files, and the embodiments thereof are described in detail later.

The processor 12 is coupled to the storage 11. The processor 12 may be a central processing unit (CPU), a graphic processing unit (GPU), or other programmable general-purpose or special-purpose microprocessor, digital signal processor (DSP), programmable controller, field programmable gate array (FPGA), application-specific integrated circuit (ASIC), neural network accelerator, or other similar elements or combinations of the above elements. In an embodiment, the processor 12 is used to execute all or part of the operations of the computing apparatus 10 and may load and execute each of the program codes, the software modules, the files, and the data stored in the storage 11. In some embodiments, the function of the processor 12 may be implemented through a software or a chip.

In an embodiment, the processor 12 executes the causal analysis module 121, the causal graph construction module 122, the adjustment module 123, and/or the training module 124. The functions of each of the modules 121 to 124 are described in detail in subsequent embodiments.

In the following, the method described in the embodiment of the disclosure is described with reference to various devices, components, and modules in the computing apparatus 10. Each process of the method may be adjusted according to the implementation situation.

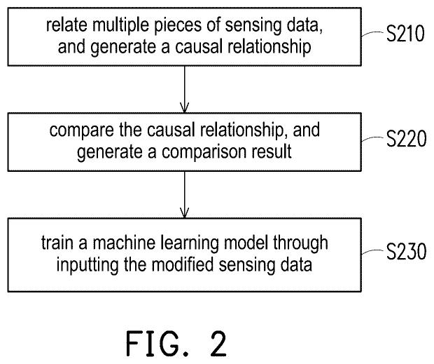

FIG. 2 is a flow chart of a data correction method for machine learning according to an embodiment of the disclosure. Referring to FIG. 2, the processor 12 relates multiple pieces of sensing data through the causal analysis module 121 and generates a causal relationship between the multiple pieces of sensing data (step S210). Specifically, a type of sensing data may be video/static images, location information (for example, satellite locationing coordinates or relative location to a reference object), depth information, object sensing data (for example, relative distance of an object and/or or direction value), physiological sensing data (such as heartbeat and/or pupil image), motion sensing data (such as speed, direction, acceleration, angular velocity, and/or magnetic intensity value), weather (such as humidity, rainfall, and/or temperature), and/or road conditions (e.g., traffic jams or construction conditions).

In an application scenario, a camera mounted on the vehicle captures images or records videos, and obtains video/static images accordingly. However, depending on different application scenarios, the type of the sensing data may also change.

In an embodiment, the processor 12 may identify the type and/or location of objects in the image/contour based on semantic segmentation algorithms (for example, RefineNet, SegNet, or PSPNet), neural network-based algorithms (for example, YOLO (you only look once), region based convolutional neural networks (R-CNN), or Fast R-CNN (Fast CNN)) or algorithms based on feature matching (for example, histogram of oriented gradient (HOG)), scale-invariant feature transform (SIFT), Harr, or speeded up robust features (SURF) feature comparison), which is accordingly used as the sensing data.

The causal relationship represents a causality from one piece of sensing data/variable to another piece of sensing data/variable. The sensing data may serve as causal variables. In an embodiment, a causal graph may be expressed by a graph structure composed of the causal relationships. The processor 12 may use the causal relationship between the multiple pieces of sensing data to establish the causal graph to be tested. The causal graph to be tested may express the causal relationship between the multiple pieces of sensing data.

The causal relationships between the multiple pieces of sensing data correspond to time points, temporal and spatial causal relationships, causal features, and/or spatial locations. Each of the sensing data corresponds to a time point. The time point may represent the time when the sensing data is obtained, or the time when a predetermined object/value/change in the sensing data is detected. The temporal and spatial causal relationship is a relationship between different times or the same time at different spatial locations or the same spatial location. For example, the temporal and spatial causal relationship is a continuity of road lines. The continuity corresponds to a connection relationship of the road line at different locations, and the relationship of arriving at different locations of the road line at different time points. However, the temporal and spatial causal relationship is not limited to the road lines. The causal features may be image features, sound features, environmental features, or other application features. Each piece of the sensing data corresponds to a spatial location. The spatial location may represent the location where the sensing data is obtained, or the location where a predetermined object/value/change in the sensing data is detected. For example, the location of the road line in the image.

In an embodiment, the type of the sensing data includes images, and the causal relationship between the multiple pieces of sensing data includes the relationship between an object in each of the images and the same object or different objects in another image. The causal relationship may be related in time and/or space. There is a temporal causal relationship between a first sensing data and a second sensing data. For example, after observing an object in the first image, the same object appears in the second image. There is a spatial causal relationship between a third sensing data and a fourth sensing data. For example, two images corresponding to different objects located at two locations are detected at the same time. There is a spatial and temporal causal relationship between a fifth sensing data and a sixth sensing data. For example, two images corresponding to different objects located at two locations are respectively and simultaneously detected at two time points.

In an embodiment, the processor 12 executes the causal graph construction module 122, and the causal graph construction module 122 may generate the causal graph to be tested by inputting the multiple pieces of sensing data into the causal graph model. The causal graph model is trained through continuous time Bayesian network (CTBN), dynamic Bayesian network (DBN), probability graphical model (PGM), or structural equation modeling (SEM). The causal graph model is trained and knows the relationship between multiple pieces of training data and specific causal relationships. Therefore, by inputting the sensing data to the causal graph model, the causal graph model may output the causal graph to be tested corresponding to the multiple pieces of sensing data.

In an embodiment, the processor 12 may input the multiple pieces of sensing data to the feature analysis model to generate the causal features between the multiple pieces of sensing data. The causal features serve as causal variables. The feature analysis model is trained through unsupervised causal feature learning, semi-supervised causal feature learning, reinforcement causal feature learning, or deep causal feature learning algorithms.

The feature analysis model is trained and knows the relationship between the multiple pieces of training data and feature relationships. Therefore, by inputting the sensing data to the feature analysis model, the feature analysis model may output the causal features corresponding to the multiple pieces of sensing data.

In an embodiment, the processor 12 may cluster highly related causal variables through a spatial clusterer, and may cluster the causal variables with the highly related effect variables through an effect spatial clusterer. Next, each cluster (including the highly related causal variables) is used to extract the causal features. The causal features may be used to create a reference causal graph and identify the causal variables represented by problematic sensing data (e.g., the image or pixels thereof).

Referring to FIG. 2, the processor 12 compares the causal relationship through the adjustment module 123 and generates a comparison result (step S220). Specifically, the causal relationship between the multiple pieces of sensing data is as described in step S210, and is not repeated herein. In an embodiment, the adjustment module 123 compares the causal relationship with a reference causal relationship. The reference causal relationship is a reference, golden, correct, or standard causal relationship. The reference causal relationship is established in advance. The processor 12 may obtain a reference causal variable (the type of which may refer to the type of the sensing data). Then, for example, a road surface is continuously photographed through a camera mounted on a vehicle, and the images are used as the reference causal variables. Another example is generating the reference causal variables based on geographic information. The processor 12 may generate the reference causal relationship between the reference causal variables.

In an embodiment, the reference causal relationship corresponds to the time point, the temporal and spatial causal relationship, the causal feature, and/or the spatial location. For descriptions of the time point, the temporal and spatial causal relationship, the causal feature, and/or the spatial location, please refer to the foregoing descriptions and are not repeated herein.

In an embodiment, the causal graph may be expressed by the graph structure composed of the causal relationship. The processor 12 may create the reference causal graph using the reference causal relationship. The reference causal relationship may be expressed using the reference causal graph.

In an embodiment, the processor 12 executes the causal graph construction module 122, and the causal graph construction module 122 may generate the reference causal graph by inputting the reference causal variables into the causal graph model. The causal graph module is trained and knows the relationship between the multiple pieces of training data and the specific causal relationships. Therefore, by inputting the reference causal variables into the causal graph model, the causal graph model may output the reference causal graphs corresponding to the reference causal variables.

In an embodiment, the processor 12 may generate the causal features between the reference causal variables by inputting the reference causal variables into the feature analysis model. The causal features may serve as the reference causal variables. By imputing the reference causal variables to the feature analysis model, the feature analysis model may output the causal features corresponding to the reference causal variables.

In an embodiment, the reference causal relationship and/or the reference causal graph are generated by an external apparatus. The processor 12 may obtain the reference causal relationship and/or the reference causal graph though a communication transceiver (for example, a wireless network card, an optical fiber network, a mobile communication transceiver circuit or a transmission interface).

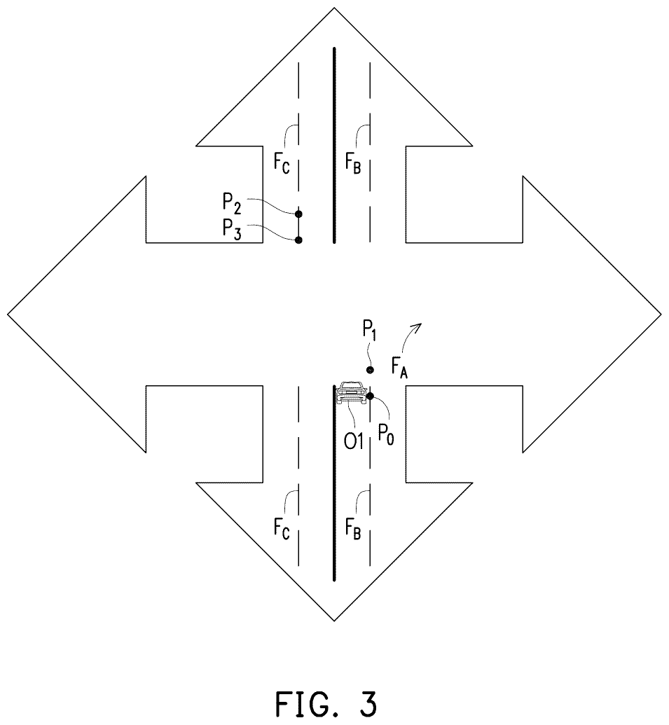

FIG. 3 is a schematic diagram illustrating an application scenario of road driving according to an embodiment of the disclosure. Referring to FIG. 3, the application scenario is that a vehicle O1 drives to an intersection. The reference causal variables may be a satellite positioning coordinate F_{A} of the vehicle O1 and road lines F_{B} and F_{C} captured by a camera mounted on the vehicle O1 (the causal features correspond to the texture of lane lines). At a time point t₀, the vehicle O1 is located at a location P₀. At a time point t₁, the vehicle O1 is located at a location P₁.

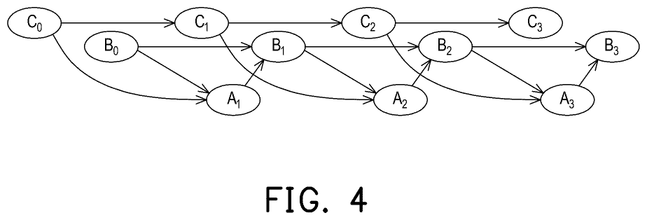

FIG. 4 is a schematic diagram illustrating the reference causal graph corresponding to FIG. 3 according to an embodiment of the disclosure. Referring to FIGS. 3 and 4, based on the reference causal variables in FIG. 3, the reference causal graph shown in FIG. 4 may be constructed. Each node A₁-A₃, B₀-B₃, and C₀-C₃ in the reference causal graph corresponds to a reference causal variable. “A”, “B”, and “C” in symbols of the nodes A₁-A₃, B₀-B₃, and C₀-C₃ respectively correspond to the satellite positioning coordinate F_{A} and the road lines F_{B} and F_{C}. The subscripts “0”, “1”, “2”, and “3” in the symbols of the nodes A₁-A₃, B₀-B₃, and C₀-C₃ correspond to time points to, t₁, t₂, and t₃ respectively. For example, the node A₁ represents the satellite positioning coordinate F_{A} of the time point t₁, the node B₀ represents the road line F_{B} of the time point t₀, and the node C₃ represents the road line F_{C} of the time point t₃. The rest may be deduced in this way and is not repeated herein. Arrows between the nodes A₁-A₃, B₀-B₃, and C₀-C₃ in FIG. 4 represent the causal relationship from one node to another node. A head of the arrow represents a cause, and a tail of the arrow represents an effect. There are multiple different reference causal variables corresponding to the same time point, which means that the reference causal variables have a spatial causal relationship. For example, the satellite positioning coordinates F_{A} and the road lines F_{B} and F_{C} at the time point t₁ have the causal relationship at the locations. The same reference causal variable has connecting lines at different time points, which means that the reference causal variable has a temporal causal relationship. For example, the road line F_{B} is captured from the time point t₀ to the time point t₃.

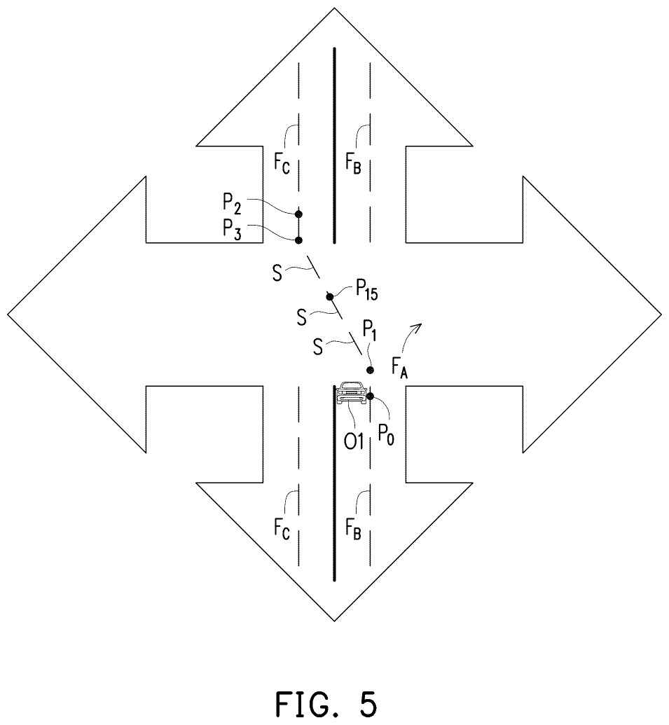

FIG. 5 is a schematic diagram illustrating an application scenario of information deception according to an embodiment of the disclosure. Referring to FIG. 5, assuming that in the same application environment as FIG. 3, stickers S of three long strips are affixed to the road surface. The stickers S are connected end to end, which is similar to the road line F_{B}. It is worth noting that the stickers S extend the road line F_{B} to the road line F_{C}. When an in-vehicle system of the vehicle O1 suffers a network attack or reads tampered error information, the in-vehicle system believes that the intersection is still the road line F_{B}. When passing through the intersection, the in-vehicle system thinks that the road line F_{B} is continuously detected. Therefore, at a time point t_{1.5}, the vehicle O1 is located at a location P₁₅. At the time point t₂, the vehicle O1 is located at a location P₂. At the time point t₃, the vehicle O1 is located at a location P₃. That is, the vehicle O1 moves along the stickers S to the road line F_{C}.

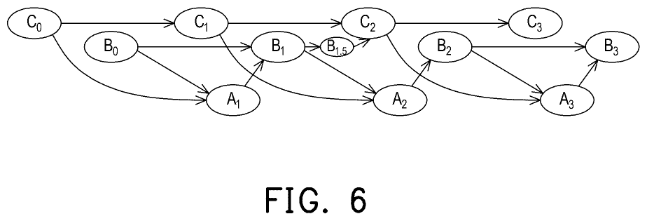

FIG. 6 is a schematic diagram illustrating the causal graph to be tested corresponding to FIG. 5 according to an embodiment of the disclosure. Referring to FIGS. 5 and 6, based on the sensing data in FIG. 5, the causal graph to be tested shown in FIG. 6 may be constructed. Similarly, each of the nodes A₁-A₃, B₀-B₃, and C₀-C₃ in the causal graph to be tested corresponds to a piece of the sensing data. “A”, “B”, and “C” in the symbols of the nodes A₁-A₃, B₀-B₃, B_{1.5}, and C₀-C₃ respectively correspond to the satellite positioning coordinate F_{A} and the road lines F_{B} and F_{C}. The subscripts “0”, “1”, “1.5”, “2”, and “3” in the symbols of the nodes A₁-A₃, B₀-B₃, B_{1.5}, and C₀-C₃ respectively correspond to the time points to, t₁, t_{1.5}, t₂, and t₃. For example, the node A₁ represents the satellite positioning coordinate F_{A} of the time point t₁, the node B₀ represents the road line F_{B} of the time point t₀, and the node C₃ represents the road line F_{C} of the time point t₃. The rest may be deduced in this way and is not repeated herein. The time point t_{1.5} is between the time point t₁ and the time point t₂. The arrows between the nodes A₁-A₃, B₀-B₃, B_{1.5}, and C₀-C₃ in FIG. 6 represent the causal relationship from one node to another node. The head of the arrow represents the cause, and the tail of the arrow represents the effect. There are multiple different pieces of sensing data corresponding to the same time point at the same time, which means that the multiple pieces of sensing data have the spatial causal relationship. The same sensing data has connections at different time points, which means that the sensing data has the temporal causal relationship.

It is worth noting that, referring to FIGS. 5 and 6, at the time point t_{1.5}, the vehicle O1 is mistakenly thought to be located on the road line F_{B}, but the vehicle O1 is actually located on the sticker S. Therefore, the node B₁ and the node B_{1.5} have the temporal causal relationship. Furthermore, the vehicle O1 is located on the road line F_{C} at the time point t₂. Therefore, the node B_{1.5} has the temporal causal relationship with the node C₂, and the node B₁ is connected to the node C₂ via the node B_{1.5}. However, according to the reference causal graph shown in FIG. 4, the node B₁ is connected to the node C₂, and the node B₁ and the node B₂ have the temporal causal relationship. The difference between FIG. 4 and FIG. 6 may be used as the comparison result between the causal relationship between the multiple pieces of sensing data and the reference causal relationship.

In an embodiment, the processor 12 may compare the causal graph to be tested and the reference causal graph to generate the comparison result between the causal relationship between the multiple pieces of sensing data and the reference causal relationship. The comparison result may be that the nodes or the connections in the causal graph to be tested are different from the reference causal graph, and/or the comparison result may be that the nodes or the connections in the causal graph to be tested are the same as one in the reference causal graph. For example, compared with FIG. 4, FIG. 6 adds the node B_{1.5}. The node B_{1.5} is connected to the node C₂. For another example, compared with FIG. 4, FIG. 6 also has the node B₁, and the node B₁ is also connected to the node B₂.

In an embodiment, the processor 12 may compare at least one of the time point, the temporal and spatial causal relationship, the causal feature, and the spatial location corresponding to the causal relationship between the multiple pieces of sensing data with at least of the time point, the temporal and spatial causal relationship, the causal feature, and the spatial location corresponding to one or more reference causal relationships. That is to say, the processor 12 compares the time points of the causal relationship between the multiple pieces of sensing data and the corresponding time points of the reference causal relationship, compares the temporal and spatial causal relationships of the causal relationship between the multiple pieces of sensing data and the corresponding temporal and spatial causal relationship of the reference causal relationship, compares the causal features of the causal relationship between the multiple pieces of sensing data and the causal features of the reference causal relationship, and/or compares the spatial location of the causal relationship between the multiple pieces of sensing data and the corresponding spatial location of the reference causal relationship.

Taking FIG. 4 and FIG. 6 as an example, whether the time point t₂ corresponds to the nodes A₂, B₂, and C₂ is compared; and whether the node B₁ corresponding to the time point t₁ is connected to the node B₂ is compared.

In an embodiment, the processor 12 may use the causal relationship between the multiple pieces of sensing data to generate a feature vector to be tested. Elements in the feature vector to be tested may correspond to values of the sensing data or the nodes of the causal graph to be tested. In response to being not in a numerical form, text or symbols may be converted into the numerical form through, for example, one-hot encoding, feature classification, or other encoding. The elements in the feature vector to be tested may also correspond to the connections between the nodes of the causal graph to be tested.

On the other hand, the processor 12 may generate a reference feature vector using the reference causal relationship. Similarly, elements in the reference feature vector may correspond to values of reference causal variables or nodes of the reference causal graph. In response to being not in the numerical form, the text or the symbol may be converted into the numerical form through, for example, the one-bit hot encoding, the feature classification, or other encoding. The elements in the reference feature vector may also correspond to the connections between the nodes of the reference causal graph.

Then, the processor 12 may compare the difference between the feature vector to be tested and the reference feature vector to generate the comparison result between the causal relationship between the multiple pieces of sensing data and the reference causal relationship. For example, the difference between two vectors is determined by calculating cosine similarity, mean square error, root mean square error, or other error functions. Taking the cosine similarity as an example, in response to the causal graph to be tested and the reference causal graph having similar or identical connection patterns and structural features, there is a smaller angle between the feature vector to be tested and the reference feature vector, resulting in a high cosine similarity score. On the other hand, in response to the causal graph to be tested and the reference causal graph have different connection patterns and structural features, there is a larger angle between the feature vector to be tested and the reference feature vector, resulting in a lower cosine similarity score.

In some embodiments, the values in the feature vector to be tested and/or the reference feature vector may be performed a normalizing process. For example, when the vehicle is traveling at different speeds and the sensing data and the reference causal variables are obtained through the camera, the corresponding relationship between the time point and the sensing data may be modified.

Referring to FIG. 2, the processor 12 uses the adjustment module 123 and inputs the modified sensing data to train a machine learning model (step S230). Specifically, the comparison result corresponds to the difference between the sensing data and the reference causal variable. In an embodiment, the reference causal variable is a correct, standard, or golden causal variable. The processor 12 may modify problematic, erroneous, or different sensing data to corresponding reference causal variables. As shown in FIG. 5, the sensing data corresponding to the time point t_{1.5} is corrected from “the road line F_{B} is detected” to “the road line F_{B} is not detected”, and accordingly a pixel or an image region corresponding to the sticker S in the image is deleted/filtered or replace the image of the sticker S with a road image.

In an embodiment, the comparison result is used to modify the sensing data.

In an embodiment, in response to the comparison result being that a node or a connection in the causal graph to be tested is different from the reference causal graph, the processor 12 may delete, add, or change the node or the connection, and accordingly change the data corresponding to the node or the connection in the multiple pieces of sensing data. For example, in response to the reference causal graph not having a first node, the first node is deleted from the causal graph to be tested. For another example, in response to the reference causal graph being connected from a second node to a third node, a connection of the second node to the third node is added to the causal graph to be tested. For another example, in response to the reference causal graph being connected from the second node to the third node while the causal graph to be tested being connected from the second node to a fourth node, the connection of the second node in the causal graph to be tested is changed to a connection to the third node.

Due to the deletion, addition, or change of nodes and/or connections, the sensing data corresponding to the corrected causal graph to be tested is changed. For example, in response to a node being deleted, the sensing data at a certain time point is deleted. For another example, in response to a new node being added, the sensing data at a certain time point is added. For another example, in response to the connection between the nodes being changed, the values or the records in the sensing data are modified.

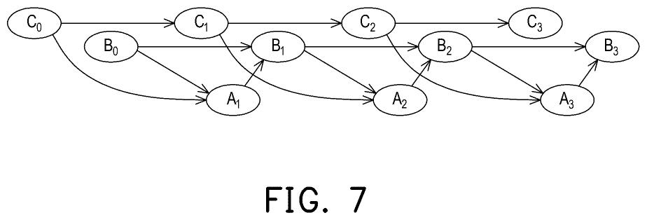

For example, FIG. 7 is a schematic diagram illustrating a modified causal graph to be tested according to an embodiment of the disclosure. Referring to FIG. 6 and FIG. 7, the node B_{1.5} is deleted from FIG. 6, and the node B₁ is connected to the node B₂, forming the corrected causal graph to be tested shown in FIG. 7 (same as the reference causal graph shown in FIG. 4).

In an embodiment, the processor 12 may optionally filter, delete, add, or change the time point, the temporal and spatial causal relationship, the causal feature, and the spatial location corresponding to the multiple pieces of sensing data based on the difference (i.e., the different part) in at least one of the time point, the temporal and spatial causal relationship, the causal feature, and the spatial location between the causal relationships of the multiple pieces of sensing data and the reference causal relationship, so that the causal relationship and the reference causal relationship of the multiple pieces of sensing data are consistent in at least one of the time point, the temporal and spatial causal relationship, the causal feature, and the spatial location.

In an embodiment, the modified sensing data is used to train the machine learning model. The machine learning model is trained through a machine learning algorithm. The machine learning algorithm is, for example, YOLO, convolutional neural network (CNN), CTBN, DBN, or other algorithms. The modified sensing data may be used as a training sample and may be input to the machine learning model to train the machine learning model.

In an embodiment, the processor 12 may determine the causal relationship between the modified sensing data through the adjustment module 123. For example, the corrected causal graph to be tested, the corrected time point, the temporal and spatial causal relationship, the causal feature, and/or the spatial location shown in FIG. 7. Then, the processor 12 may use the training module 124 to train or test the machine learning model by inputting the causal relationship between the modified sensing data or the corrected causal graph to be tested to the machine learning model. The machine learning model may take the corrected causal relationship or the causal graph to be tested as an input sample and regard the corrected causal relationship or the causal graph to be tested as the correct, standard, or golden input sample. After training, the machine learning model may be used for image recognition, assisted driving, or other inference applications.

For example, during the training process, the causal relationship between the sensing data/the variables in multiple frames of a dynamic video image is identified. Next, the CTBN is used to model temporal dynamics of the sensing data/the variables, and the machine learning model is trained to make predictions based on the causal relationships. During a testing phase, the CTBN may be used to predict a future state of a system based on the current sensing data and the causal relationship between causal variables. In response to the machine learning model detecting any differences between the predicted and actual states, corrections may be made to prevent any potential attacks.

In another embodiment, the processor 12 may determine the modified sensing data through the adjustment module 123. For example, the corrected time points, the image features, and/or the spatial locations. Then, the processor 12 may use the training module 124 to train or test the machine learning model by inputting the modified sensing data to the machine learning model. The machine learning model may take the modified sensing data as the input sample and regard the modified sensing data as the correct, standard, or golden input sample. After training, the machine learning model may be used for image recognition, assisted driving, or other inference applications.

In an embodiment, the processor 12 may use the corrected causal graph to be tested as an input and regard the corrected causal graph to be tested as a set of rules that control system behavior. The processor 12 may use the rules to decide how to control an autonomous vehicle. For example, the processor 12 may use the causal graph to determine a probability of an event occurring based on the current state of the system. Then, the processor 12 may use the probability to determine how to control the autonomous vehicle. In an embodiment, the processor 12 may use the corrected causal graph to be tested to identify potential problems in the system and take a correction measure to prevent the problems from occurring. For example, in response to the causal graph indicating that there is a high likelihood that a child suddenly crosses the road, the processor 12 may take the correction measure to prevent the accident from occurring. The correction measure may be accomplished by slowing down the vehicle, sounding an alarm, or taking other appropriate measures to avoid a collision.

Another embodiment of the disclosure provides a non-transitory computer-readable medium that stores a computer program loaded into the processor to execute each step of the above planned optimization method (as shown in the embodiments in FIGS. 2 to 7). The computer program may include multiple program codes, and after the processor 12 loads and executes the program codes, the planned optimization method may be completed and the functions of the computing apparatus 10 may be realized.

To sum up, in the data correction method and the computing apparatus used for machine learning, and the computer-readable medium of the embodiments of the disclosure, the correctness of the sensing data is known through comparing the causal relationship, and the sensing data, the corresponding causal relationship, and/or the corresponding causal graph is corrected based on the comparison result. Thereby, the correctness and the reliability of the sensing data used for training or testing the machine learning model may be ensured, and accurate predictions may be gained in real-life scenarios.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A data correction method for machine learning, comprising:
relating a plurality of pieces of sensing data and generating a causal relationship;
comparing the causal relationship and generating a comparison result, wherein the comparison result is configured to modify the plurality of pieces of sensing data; and
training a machine learning model by inputting a plurality of pieces of modified sensing data.

2. The data correction method for machine learning according to claim 1, wherein comparing the causal relationship comprises:
creating a causal graph to be tested by the causal relationship;
creating a reference causal graph by at least one reference causal relationship; and
comparing the causal graph to be tested and the reference causal graph to generate the comparison result.

3. The data correction method for machine learning according to claim 2, further comprising:
deleting, adding, or changing a node or a connection in response to the comparison result being that the node or the connection in the causal graph to be tested is different from the reference causal graph, and accordingly changing the data of the plurality of pieces of sensing data corresponding to the node or the connection.

4. The data correction method for machine learning according to claim 2, wherein creating the causal graph to be tested by the causal relationship comprises:
generating the causal graph to be tested by inputting the plurality of pieces of sensing data into a causal graph model, wherein the causal graph model is trained through a continuous time Bayesian network (CTBN), a dynamic Bayesian network (DBN), a probability graphical model (PGM), or a structural equation modeling (SEM).

5. The data correction method for machine learning according to claim 1, wherein the causal relationship corresponds to at least one of a time point, a temporal and spatial causal relationship, a causal feature, and a spatial location, and comparing the causal relationship comprises:
comparing at least one of the time point, the temporal and spatial causal relationship, the causal feature, and the spatial location corresponding to the causal relationship with at least one of the corresponding time point, the corresponding temporal and spatial causal relationship, and the corresponding causal feature, and the corresponding spatial location of at least one reference causal relationship.

6. The data correction method for machine learning according to claim 5, wherein the temporal and spatial causal relationship is a continuity of a road line, the causal feature is an image feature, and the spatial location is a location of the road line.

7. The data correction method for machine learning according to claim 1, wherein comparing the causal relationship comprises:
generating a feature vector to be tested by the causal relationship;
generating a reference feature vector by at least one reference causal relationship; and
comparing a difference between the feature vector to be tested and the reference feature vector to generate the comparison result.

8. The data correction method for machine learning according to claim 5, wherein relating the plurality of pieces of sensing data comprises:
generating a causal feature of the plurality of pieces of sensing data by inputting the plurality of pieces of sensing data into a feature analysis model, wherein the feature analysis model is trained through unsupervised causal feature learning, semi-supervised causal feature learning, reinforcement causal feature learning, or deep causal feature learning algorithms.

9. The data correction method for machine learning according to claim 1, further comprising:
training the machine learning model by inputting the causal relationship into the machine learning model.

10. The data correction method for machine learning according to claim 1, further comprising:
modifying the plurality of pieces of sensing data according to the comparison result, and generating the plurality of pieces of modified sensing data.

11. The data correction method for machine learning according to claim 1, wherein a type of the plurality of pieces of sensing data comprises an image, and the causal relationship comprises a relationship between an object in each of the images and the same object or the different object in another one of the images.

12. A computing apparatus for machine learning, comprising:
a storage, storing a program code; and
a processor, coupled to the storage, loading the program code and executing:
determining a causal relationship between a plurality of pieces of sensing data;
comparing a causal relationship between the plurality of pieces of sensing data with at least one reference causal relationship to generate a comparison result, wherein the at least one reference causal relationship is established in advance; and
correcting the plurality of pieces of sensing data according to the comparison result, wherein a plurality of pieces of modified sensing data are configured to train a machine learning model.

13. The computing apparatus for machine learning according to claim 12, wherein the processor further executes:
creating a causal graph to be tested by a causal relationship between the plurality of pieces of sensing data;
creating a reference causal graph by the at least one reference causal relationship; and
comparing the causal graph to be tested and the reference causal graph to generate the comparison result.

14. The computing apparatus for machine learning according to claim 13, wherein the processor further executes:
deleting, adding, or changing a node or a connection in response to the comparison result being that the node or the connection in the causal graph to be tested is different from the reference causal graph, and accordingly changing the data in the plurality of pieces of sensing data corresponding to the node or the connection.

15. The computing apparatus for machine learning according to claim 13, wherein the processor further executes:
generating the causal graph to be tested by inputting the plurality of pieces of sensing data to a causal graph model, wherein the causal graph model is trained through a continuous-time Bayesian network, a dynamic Bayesian network, a probability graph model, or a structural equation model.

16. The computing apparatus for machine learning according to claim 12, wherein the causal relationship between the plurality pieces of sensing data corresponds to at least one of a time point, a temporal and spatial causal relationship, a causal feature, and a spatial location, and the processor further executes:
comparing at least one of the time point, the temporal and spatial causal relationship, the causal feature, and the spatial location corresponding to the causal relationship between the plurality of pieces of sensing data with at least one of the corresponding time point, the corresponding temporal and spatial causal relationship, the corresponding causal feature, and the corresponding spatial location of the at least one reference causal relationship.

17. The computing apparatus for machine learning according to claim 12, wherein the processor further executes:
generating a feature vector to be tested by the causal relationship between the plurality of pieces of sensing data;
generating a reference feature vector by the at least one reference causal relationship; and
comparing a difference between the feature vector to be tested and the reference feature vector to generate the comparison result.

18. The computing apparatus for machine learning according to claim 16, wherein the processor further executes:
generating a causal feature between the plurality of pieces of sensing data by inputting the plurality of pieces of sensing data into a feature analysis model, wherein the feature analysis model is trained through unsupervised causal feature learning, semi-supervised causal feature learning, reinforcement causal feature learning, or deep causal feature learning algorithms.

19. The computing apparatus for machine learning according to claim 12, wherein the processor further executes:
training the machine learning model by inputting the causal relationship into the machine learning model; or
the processor further executes:
modifying the plurality of pieces of sensing data according to the comparison result, and generating the plurality of pieces of modified sensing data.

20. A non-transitory computer-readable medium, loading a program code through a processor and executing the following:
relating a plurality of pieces of sensing data and generating a causal relationship;
comparing the causal relationship and generating a comparison result, wherein the comparison result is configured to modify the plurality of pieces of sensing data; and
training a machine learning model by inputting a plurality of pieces of modified sensing data.
